(19) United States
(12) Patent Application Publication
(10) Pub. No.: US 2003/0095567 A1
(43) Pub. Date: May 22, 2003

(54) Real time protocol packet handler

(76) Inventors: Man Kuk Lo, Hong Kong (CN); Hing Leung Yiu, Hong Kong (CN); Kwok Wai Cheng, Hong Kong (CN)

Correspondence Address: MOTOROLA, INC., CORPORATE LAW DEPARTMENT - #56-238, 3102 NORTH 56TH STREET, PHOENIX, AZ, 85018, US

(21) Appl. No.: 09/989,265

(22) Filed: Nov. 20, 2001

(51) Int. Cl. H04J 3/16

(52) U.S. Cl. 370/466; 370/474

(57) ABSTRACT

A Real Time Protocol (RTP) packet handler includes a protocol processor (44) coupled to a communications medium (26) and a central processing unit (CPU) (46). The protocol processor (44) receives IP packets (24) transmitted over the communications medium (26). Operating system (OS) software executing on the CPU (46) controls the operation of the protocol processor (44) via a host interface (57) and a dual port RAM (58). A switch (50) routes RTP type IP packets to a RTP handler module (48) running on the protocol processor (44). The RTP packet handler module (48) processes RTP packets. Non-RTP packets are processed by the OS software (46).

### BACKGROUND OF THE INVENTION

The present invention relates to a real time protocol (RTP) packet handler.

Voice over IP (VoIP) refers to the making of telephone calls and the sending of faxes over IP (Internet Protocol) based data networks. Recently, VoIP has been replacing many functions heretofore provided via traditional telephone systems. VoIP can be used to enhance traditional telephony applications. For example, voice messages can be prepared using a telephone and then delivered to an integrated voice/data mailbox using Internet or intranet services, allowing voice annotated documents, multimedia files, etc.

All VoIP packets are made up of two components, IP/UDP/RTP headers and a payload or voice samples. FIG. 1 shows a VoIP packet 10 having an IP header 12, a UDP header 14, an RTP header 16, and an RTP payload 18. UDP stands for User Datagram Protocol. The IP header 12, which is 20 bytes, specifies the format of packets or datagrams and the addressing scheme. UDP runs on top of IP networks and is used primarily for broadcasting messages over a network. UDP establishes a virtual connection between a destination and a source. Thus, the UDP header 14, which is 8 bytes, specifies the datagram source and destination. RTP is an Internet-standard protocol for the transport of real-time data, including audio and video. The voice samples, which make up the RTP payload 18, are processed and compressed by a digital signal processor (DSP) and may vary in size based on the codec.

The IP+UDP+RTP packet headers 12-16 can be compressed using cRTP (compressed RTP), from 40 Bytes to a 2 or 4 bytes compressed header 22. Thus, the VoIP packet 10 is transmitted as a compressed VoIP packet 20, which provides significant bandwidth savings.

Referring now to FIG. 2, a schematic diagram illustrating the conventional manner of handling an RTP packet, such as the packet 10 or the compressed packet 20, is shown.

A packet 24 is transmitted over a communication medium 26, such as an Ethernet, and received by a processor 28, such as central processing unit (CPU). The CPU 28 includes a memory that stores a control program or operating system 30 that includes a routine for managing a VoIP call setup and control protocol stack, such as an H.323 stack. H.323 is a standard approved by the International Telecommunication Union (ITU) that defines how audiovisual conferencing data is transmitted across networks. H.323 enables users to participate in the same conference even though they are using different videoconferencing applications. However, other control protocol stacks may be implemented, such as MGCP, H.248, SIP, etc.

The packet 24 is first processed as an IP packet by an IP layer 32 of the operating system 30, which reads and processes the IP header 12. The packet 24 is then processed by an UDP layer 34, which reads and processes the UDP header 14. The packet 24 is then passed to a RTP layer 36 via a port m 38, where the RTP header 16 is processed. Finally, the RTP payload 18 is passed to an upper layer 40 for processing application software.

With all of these layers 32, 34, 36 being handled by the operating system 30 and the CPU 28, the processing of RTP packets is rather slow.

RTP allows each source to be assigned its own independent RTP stream of packets. For example, for a videoconference between two participants, four RTP streams could be opened. That is, each participant having two one-way streams, one for transmitting the audio and one for transmitting the video. Some encoding techniques like MPEG1 and MPEG2 bundle the audio and video into a single stream during the encoding process. When the audio and video are bundled by the encoder, then only one RTP stream is generated in each direction. RTP also supports data transfer to multiple destinations using multicast distribution if provided by the underlying network. For a many-to-many multicast session, all of the senders and sources typically send their RTP streams into the same multicast tree with the same multicast address. Thus, with the increase in popularity of VoIP, there is an even greater increase in the amount of VoIP traffic. It would be advantageous to have a processor equipped to efficiently process VoIP packets.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown.

In the drawings:

FIG. 1 is a diagram illustrating a conventional RTP packet and a conventional compressed RTP packet;

FIG. 2 is a schematic block diagram illustrating a conventional method of processing an RTP packet;

FIG. 3 is a schematic block diagram illustrating a RTP packet handler in accordance with an embodiment of the present invention;

FIG. 4 is a diagram of a RTP type IP packet for illustrating the steps performed for preparing a RTP packet to be transmitted in accordance with an embodiment of the present invention;

FIG. 5 is a diagram of an RTP type IP packet for illustrating the steps performed when a RTP packet is received in accordance with an embodiment of the present invention; and

FIG. 6 is a schematic block diagram of the protocol processor and a dual port RAM.

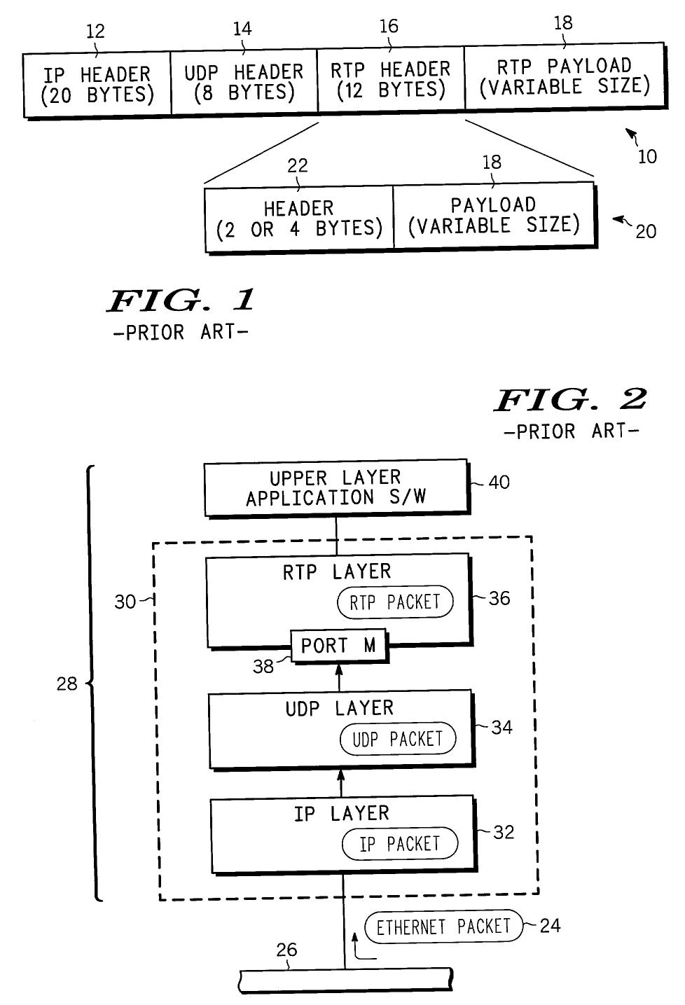

### DETAILED DESCRIPTION OF PREFERRED EMBODIMENTS

The detailed description set forth below in connection with the appended drawings is intended as a description of the presently preferred embodiments of the invention, and is not intended to represent the only forms in which the present invention may be practiced. It is to be understood that the same or equivalent functions may be accomplished by different embodiments that are encompassed within the spirit and scope of the invention. In the drawings, like numerals are used to indicate like elements throughout.

The present invention overcomes the performance bottleneck problem experienced when RTP packets are processed using a conventional CPU as described above. The present invention accelerates RTP processing by detecting RTP packets and processing them separate from other packet types. A separate routine, which may be implemented in microcode, is used to process RTP packets.

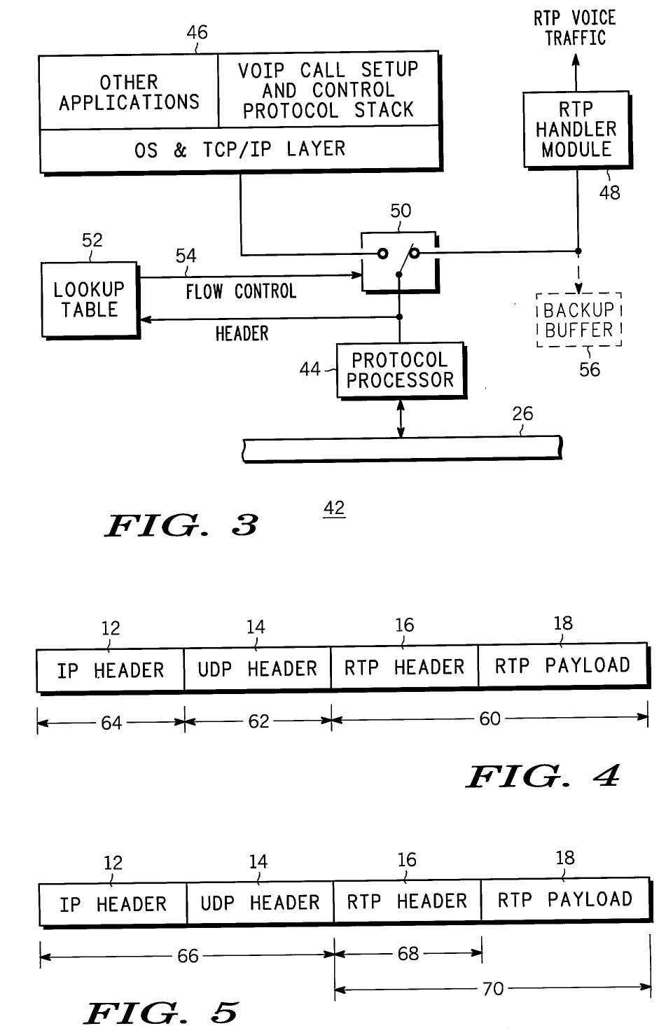

Referring now to FIG. 3, a block diagram of an RTP handler 42 in accordance with an embodiment of the invention is shown. The RTP handler 42 includes a protocol processor 44 that is connected to a communications medium, such as an Ethernet line 26. The protocol processor 44 is preferably a simple RISC processor with a memory and communications interface. Packets of information are transmitted between the protocol processor 44 and other devices and computers (not shown) via the communications medium 26 in a manner understood by those of ordinary skill in the art.

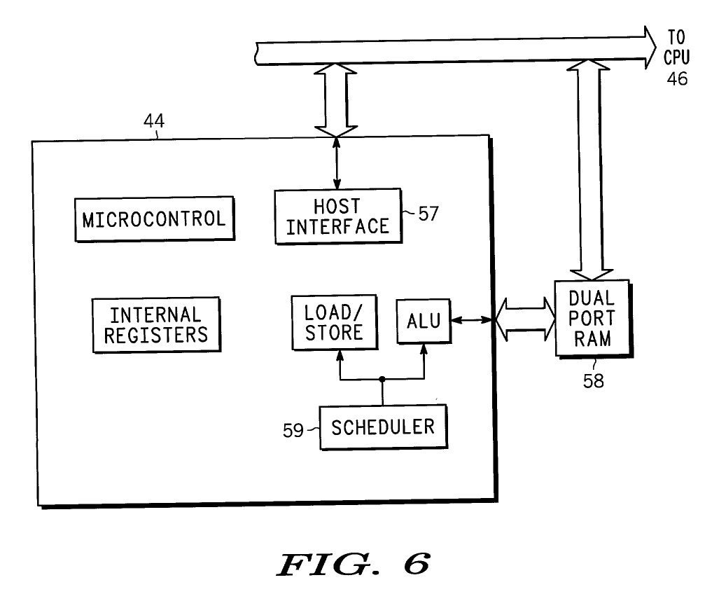

The protocol processor 44 is also connected to a central processing unit (CPU) 46 on which an operating system program executes. The protocol processor 44 does not include an actual operating system, but communicates with the CPU 46 via a host interface 57 and a dual port RAM 58 (FIG. 6). The operating system directs the operation of the CPU 46 and the protocol processor 44 via the host interface 57. Referring to FIG. 6, a schematic block diagram of the protocol processor 44 and the dual port RAM 58 is shown. The protocol processor 44 includes elements such as an ALU, load and store logic connected between the RAM 58 and the ALU, internal registers, a microcontroller, the host interface 57 and a task scheduler 59. Such processors including these logic blocks, among others, as well as operating system programs, host interfaces and task schedulers are well known by those of ordinary skill in the art. The operating system program of the CPU 46 is capable of processing packets received from and transmitted via the communication medium 26. For example, the operating system program may include a LAN interface, a TCP/IP layer, a UDP layer, a VoIP Call Protocol Stack, application programs, etc.

As discussed in more detail below, the protocol processor 44 also includes a means for detecting RTP packets. When an RTP packet is detected, it is processed by an RTP handler module 48. The protocol processor 44 includes a switch 50 that directs RTP packets to the RTP handler module 48. In the presently preferred embodiment, the switch 50 is a software switch that directs the protocol processor 44 to initiate the RTP handler module 48 and instructs the protocol processor 44 to allow the RTP handler module 48 to process detected RTP packets. Thus, IP packets are analyzed by the protocol processor 44 and if a packet is identified as an RTP packet, the packet is redirected, away from the conventional IP/UDP processing as performed on the CPU 46 by an Operating System routine, and processed by the RTP handler module 48. The RTP handler module 48 preferably comprises firmware or a microcode routine executed by the protocol processor 44. The RTP handler module 48 is thus separate from the operating system and preferably executes on a separate processor (ie., it runs on the protocol processor 44).

The RTP handler module 48, once it receives an RTP packet, will remove the IP header, the UDP header and the checksum, and the resulting RTP packet is passed to a user application running on the central processing unit 46. In FIG. 3, the RTP packet with the IP and UDP headers removed and being passed to the user application is shown as RTP voice traffic. However, as will be understood by those of skill in the art, the remaining RTP packet could also be video data.

Note that RTP packets are thus processed by the RTP handler module 48 operating on the protocol processor 44, and are not handled by the Operating System software on the CPU 46. Rather, only IP packets not identified as RTP packets are processed by the OS software of the CPU 46. More particularly, during a call setup procedure, certain information is exchanged and stored, such as the source IP address, destination IP address, UDP Source Port number, UDP destination Port number, and Payload type. After the call setup procedure, communications are established and IP packets begin to be transmitted and received by the protocol processor 44. On the transmit side, the user application supplies the IP address, UDP address and Payload type for filtering. On the receive side, received IP packets are compared to the data stored during the call setup procedure. For example, the source IP address and the UDP port source number may be stored in a lookup table 52. Then, when an IP packet is received, its source IP address and UDP port source number are obtained from the IP packet header and compared to the data in the lookup table 52. In the presently preferred embodiment, the data lookup table 52 is a part of the protocol processor 44. However, the lookup table 52 could be implemented on the CPU 46. The data lookup table 52 may also be a memory block of an external memory, such as a 256 word block of a memory. If the received IP packet headers match the stored packet headers, then a flow control signal 54 directs the switch 50 to pass the IP packet, which is an RTP type, to the RTP handler module 48 for processing. Otherwise, the received IP packet is processed in the normal manner by the OS software operating on the CPU 46. In one embodiment of the invention, when a RTP type IP packet is detected, the RTP packet is copied to a backup buffer 56. Thus, should an error or interrupt occur, the RTP packet can be easily reloaded and processing thereof restarted.

The RTP handler module 48 will remove the IP header, the UDP header and the checksum, and the resulting RTP packet is passed to the user application. These RTP packets are not passed to the operating system 46 for TCP/IP processing. However, all non-RTP packets are passed to the operating system 46 TCP/IP stack for processing.

As is understood by those of skill in the art, RTP has a data part and a control part. The control part is called RTCP (Real Time Control Protocol). In the presently preferred embodiment, the RTCP handler software is a part of the operating system program and not part of the RTP handler module 48. The RTP handler module 48 preferably comprises a plurality of separate routines, such as modules for preparing RTP packets to be transmitted and modules for processing received RTP packets.

Referring now to FIG. 4, a diagram of an RTP type packet for explaining the steps performed by the RTP handler module 48 for preparing a RTP packet to be transmitted is shown. As discussed above, the RTP type IP packet 10 includes an IP header 12, an UDP header 14, a RTP header 16 and a RTP payload 18. The RTP handler module 48 prepares RTP packets that are transmitted via the communications medium 26 to other devices. To build a RTP packet for transmission, the RTP handler module 48 performs a first step 60 in which the RTP handler module 48 generates a sequence number and a time stamp, and builds the RTP header 16. In a second step 62, the RTP handler module 48 builds the UDP header 14. Then, in a third step 64, the RTP handler module 48 builds the IP header 12.

Referring to FIG. 5, a diagram of a RTP type packet for explaining the steps performed by the RTP handler module 48 when an RTP packet is received is shown. When an IP packet 10 is received by the protocol processor 44, in a first step 66, the IP header 12 and the UDP header 14 are examined, such as by comparing them to header values prestored in the lookup table 52 during a call setup procedure. In addition, the IP and UPD headers 12, 14 are error checked. In a second step 68, if the IP packet is identified as a RTP packet during the first step 66, then the RTP packet is sorted according to its sequence number. Then, in a third step 70, the RTP header 16 and the RTP payload 18 are dispatched to an upper layer for application processing. Such application processing is understood by those of ordinary skill in the art, so it is not described herein.

As can be seen, the present invention off loads the processing of RTP packets, bypassing the OS and the protocol stack, which lightens the load on the CPU. In the prior art design, a processor can only support about four RTP sessions. In contrast, the present invention allows the processor to support more than 30 RTP sessions.

It will be understood by those of ordinary skill in the art that although the foregoing description describes the invention in terms of RTP running on top of UDP, it will be understood by those of skill in the art that RTP may be used with other suitable underlying network or transport protocols and further, that the invention may be used to accelerate processing of other types of IP packets. The invention is independent of physical transmission medium, so it can be applied to Ethernet, ATM, or other networks. Thus, it is to be understood that this invention is not limited to the particular embodiments disclosed, but covers modifications within the spirit and scope of the present invention as defined by the appended claims.

1. A Real Time Protocol (RTP) packet handler, comprising:
a protocol processor coupled to a communications medium and receiving IP packets transmitted over the communications medium;
a central processing unit connected to the protocol processor and having operating system (OS) software executing thereon and controlling the operation thereof;
means for examining the received IP packets and headers of the received IP packets to detect RTP packets; and
an RTP packet handler module executing on the protocol processor, wherein detected RTP packets are passed to the RTP packet handler module for processing and non-RTP packets are processed by the OS software.

2. The RTP packet handler of claim 1, wherein the communications medium comprises an Ethernet.

3. The RTP packet handler of claim 1, wherein the means for examining the received IP packets and detecting RTP packets comprises a lookup table for storing RTP packet headers.

4. The RTP packet handler of claim 3, wherein the RTP packet handler module comprises a microcode routine.

5. A Real Time Protocol (RTP) packet handler, comprising:
a protocol processor coupled to a communications medium and receiving IP packets transmitted over the communications medium;
a central processor having operating system (OS) software executing thereon and controlling the operation thereof;
a lookup table for storing predetermined IP packet headers;
a comparator for comparing a current IP packet header with the IP packet headers stored in the lookup table, wherein when the current IP packet header matches one of the IP packet headers stored in the lookup table, a RTP packet is detected; and
an RTP packet handler module executing on the protocol processor for processing RTP packets, wherein detected RTP packets are passed to the RTP packet handler module for processing and non-RTP packets are processed by the OS software.

6. The RTP packet handler of claim 5, wherein the RTP packet handler module comprises a microcode routine.

7. In a processor, a method of processing RTP packets, comprising the steps of:
receiving an internet protocol (IP) packet via a communication medium;
detecting an RTP packet by examining a header of the IP packet;
redirecting the IP packet to an RTP handler module based on the detecting step results when the IP packet is a RTP packet; and
processing the redirected RTP packet with the RTP handler module, wherein the RTP handler module operates on a protocol processor and an operating system operates on the processor.

8. The method of claim 7, further comprising the step of directing the IP packet to an operating system packet handling routine when the packet is not an RTP packet.

9. The method of claim 7, wherein the detecting step examines the IP packet by comparing the packet header with header values prestored in a lookup table.

10. The method of claim 7, further comprising the step of copying a detected RTP packet to a backup buffer.

11. The method of claim 7, wherein the processing step includes sorting multiple detected RTP packets according to their packet sequence numbers.

12. The method of claim 11, wherein the processing step further comprises dispatching the sorted RTP packets to a software upper layer.

13. The method of claim 12, further comprising the step of the RTP handler module building RTP packets and transmitting the built RTP packets over the communication medium.
